(19) United States
(12) Patent Application Publication
(10) Pub. No.: US 2010/0061793 A1
(43) Pub. Date: Mar. 11, 2010

(54) Million color pen

(76) Inventors: Judith Bender, Fairfield, CT (US); Jon Soriano, Sandy Hook, CT (US); Darryl Hudock, Highlands Ranch, CO (US)

Correspondence Address: GRIMES & BATTERSBY, LLP, 488 MAIN AVENUE, Suite 300, NORWALK, CT, 06851, US

(21) Appl. No.: 12/321,236

(22) Filed: Jan. 16, 2009

Related U.S. Application Data
(60) Provisional application No. 61/011,349, filed on Jan. 16, 2008.

(51) Int. Cl. B43K 5/02

(52) U.S. Cl. 401/194; 401/195

(57) ABSTRACT

A self contained multiple color writing pen has a single writing tip for dispensing a user selectable variable color ink to paper or other surfaces from an internal mixing chamber. Several internal ink reservoirs each having a different color ink, supply their ink to the mixing chamber. A user may easily change the selectable writing color even as he writes by manually moving a rotatable thumbwheel on the pen and the dispensed ink output changes quickly in response to such thumbwheel input. The number of colors selectable by a user is seemingly infinite and includes the entire color spectrum.

### CROSS-REFERENCE TO RELATED APPLICATIONS

This application claims priority benefit of U.S. provisional application Ser. No. 61/011,349 entitled “Million Color Pen” filed on Jan. 16, 2008 in the United States Patent and Trademark Office.”

### STATEMENT REGARDING FEDERALLY SPONSORED RESEARCH OR DEVELOPMENT

Not Applicable.

### FIELD OF THE INVENTION

The invention relates to the field of colored markers, pens, and the like. The market place is constantly looking for markers, pens, and the like having different colors for identification or esthetic value.

### BACKGROUND OF THE INVENTION

Many manufacturers and consumers seek writing instruments which will write, color, and or mark objects with multiple colors. This becomes a cumbersome task as most of the time an artist or consumer must have multiple instruments at his disposal to perform such a task. It is also very time consuming to identify and select a different instrument each time the user desires to use a different color. Many manufacturers have tried to solve this problem by fabricating markers have multiple colored tips, either at one end of the writing instrument or at multiple ends. This is not satisfactory as the color selection is limited to only the specific ink provided in the instrument, usually two or three discrete colors.

### BRIEF SUMMARY OF THE INVENTION

Against the foregoing background, it is the primary object of the present invention to provide a single hand-held instrument for writing, coloring or marking a suitable surface or surfaces in many different colors.

Until now, the only choice for writing, marking or coloring in many different colors was to pick up a separate instrument for each color. Although there are a few instruments that can mark in multiple colors, they are difficult to use as it requires flipping the instrument end to end or mechanically retracting one pen tip for one color and thereafter extending a separate pen tip to write in a separate color. These methods are time consuming and more importantly only provide an extremely limited choice of colors, usually two to three colors.

It is the object of the invention to create a single hand-held writing instrument whose color output can easily be varied by a user.

It is yet another object of the invention to make the writing instrument so that it can easily be operated in one hand.

It is yet still another object of the invention to sense when the writing instrument is not in use.

It is also the object of the invention allow for very quick color changes.

It is also the object of the invention to minimize the wasting of ink between color changes.

It is yet another object of the present invention to provide visual color feedback to a user as to which color has been selected for dispensing.

### BRIEF DESCRIPTION OF THE DRAWINGS

The foregoing and still other objects and advantages of the present invention will be more apparent from the detailed explanation of the preferred embodiments of the invention in connection with the accompanying drawings, wherein:

FIG. 1A is a perspective three-quarter frontal view of the million color pen showing the external features;

FIG. 1B is a cutaway view of the million color pen showing the internal features;

FIG. 2A is a perspective side view showing the million color pen held in a hand;

FIG. 2B is a perspective three-quarter frontal view showing the million color pen external features;

FIG. 2C is a perspective side view showing the million color pen external features;

FIG. 3A is a perspective side view showing the million color marker held in a hand;

FIG. 3B is a perspective three-quarter frontal view showing the million color marker external features; and

FIG. 3C is a perspective side view showing the million color marker external features.

### DETAILED DESCRIPTION OF THE INVENTION

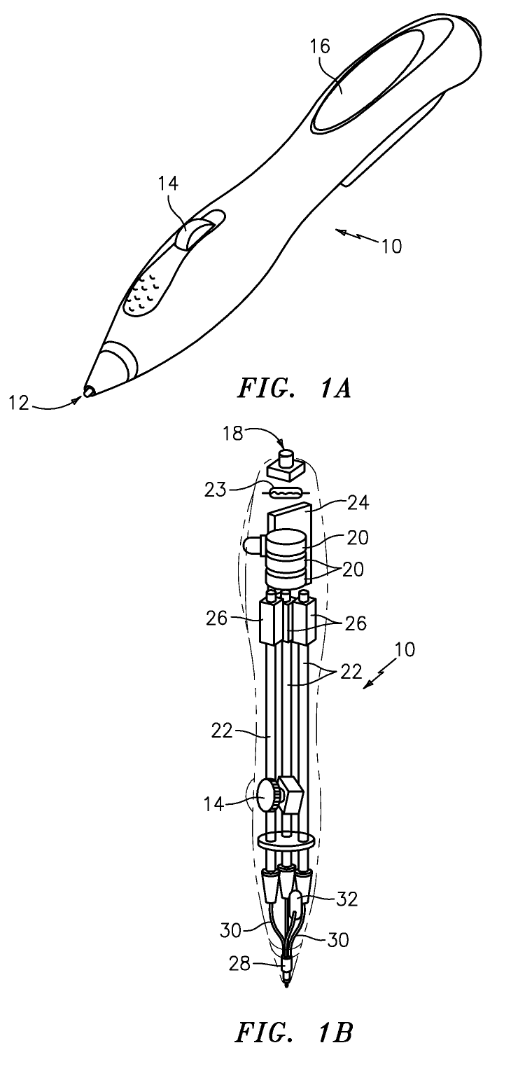

Referring to the drawings and, in particular to FIG. 1A thereof, the million color pen 10 is shown having a roller ball 12 for dispensing ink (not shown) to a suitable surface (not shown). A color selector thumbwheel 14 partially protrudes from a surface of the pen 10 so that a user may adjust the color of the dispensed ink as discussed further below. A light emitting diode 16 (LED) is mounted on a surface of the pen 10 and displays the color of the ink currently selected through the thumbwheel 14. The LED 16 provides valuable feedback to the user so that she knows what color will be dispensed when the roller ball 12 makes contact with the surface to be marked.

Now referring to FIG. 1B a cutaway view of the million color pen is shown. A power switch 18 is mounted on the non-writing end of the pen 10 so that a user may ‘click’ the pen ‘ON’ or ‘OFF’ much in the same manner as a conventional pen is put into a writing or non-writing mode. Three coin shaped batteries 20 are mounted inside the pen 10 and are replaceable or rechargeable depending upon different models. Power from the batteries 20 to various parts of the pen 10 is controlled by the power switch 18.

A tilt sensor 23 senses the physical orientation of the pen 10 and provides such information to the controller (not shown) on the circuit board 24 so as to automatically power down the pen 10 when it is horizontal or in any other presumed non-writing position.

When the pen 10 is “ON”, the color selector switch 14 provides selection information to the controller on the circuit board 24. The circuit board 24 controls an ink pumping and mixing apparatus. It consists of three syringes 22 each containing one color of ink: Cyan, Magenta, and Yellow. A fourth syringe (black) is optional but may be added to produce the color black in an economical manner. On top of each syringe 22 are pumping mechanisms 26 controlled by the circuit board 24. A plunger (not shown) inside the pumping mechanism 26 is driven by mechanical means such a linear actuator (not shown) to force ink from the syringe towards the mixing chamber 28. The actual mechanism used for pumping is defined by a design employing servos and gears which will advance a threaded rod through a nut, causing downward motion on each plunger and so causing ink to flow. The design also entails a ratcheting mechanism (not shown) so that the plungers will move down causing ink to flow or stop in an incremental motion. The servo and connected parts should advance the plunger on each syringe to a degree of precision necessary so that predefined color ratios can be achieved for a constant flow rate.

Ink will flow out of the end of each syringe 22 into small tubing 30 and the three tubes will connect to a mixing chamber 28 just before the pen dispensing tip 12 (roller ball). The dispensing tip 12 is connected directly to the mixing chamber 28. The proximity of the dispensing tip 12 to the mixing chamber 28 is critical for quick color changes and minimization of wasted ink between such changes.

It should be noted that ink delivery is independent of the actual physical orientation of the pen 10, that is, the delivery of ink is not dependent on gravity, it is pump driven. Certain pen orientations may power down the pen 10, such as horizontal because the controller believes the pen is not in use. The controller may combine tilt sensor 23 information with roller ball 12 feed back (no roller ball movement for 30 seconds) to determine that a non-use mode has been entered and power down the pen 10 to save battery 20 power. The actual parameters and limits may be varied according to a final design.

A waste mechanism will be employed to clear the mixing chamber 28 when the user changes colors and therefore speed up transition time from one color to another. Such mechanism may take the form of another syringe pump but operate in reverse sucking the waste product from the mixing chamber 28, or it may be a separate waste chamber 32 filled with absorbent material (not shown) to hold waste ink.

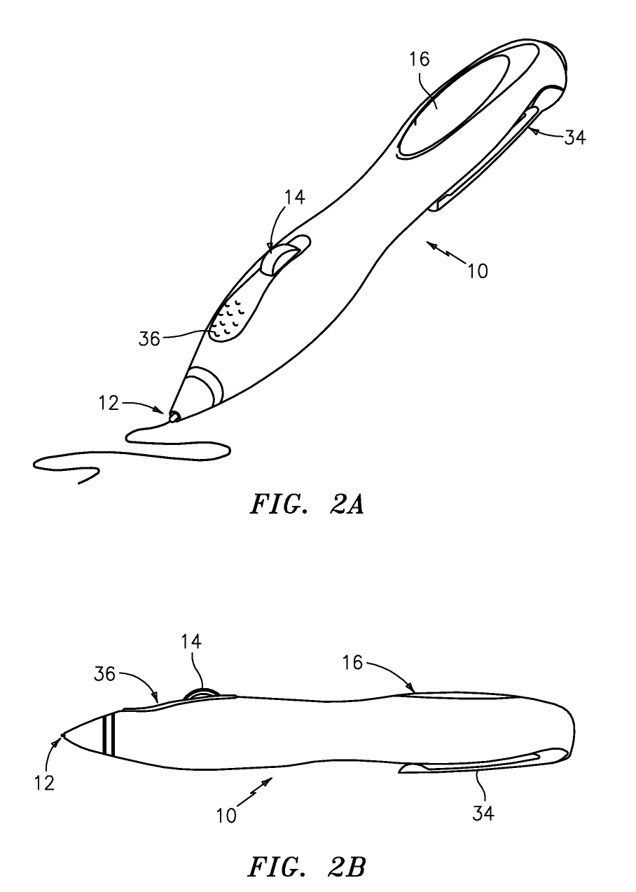

Referring now to FIG. 2A, the million color pen 10 is shown in a single hand-held operating mode.

Referring now to FIG. 2B, the million color pen 10 is shown having a dispensing tip 12, scroll wheel 14, LED color identifier 16, pocket clip 34, and rubberized finger grip 36. The roller ball 12 provides feedback to the controller so that the writing speed is known and the controller can adjust the rate of ink delivery to match such writing speed.

Referring now to FIG. 2C, the million color pen 10 is shown in a side elevation view in a horizontal position with the same features mentioned above in FIG. 2B.

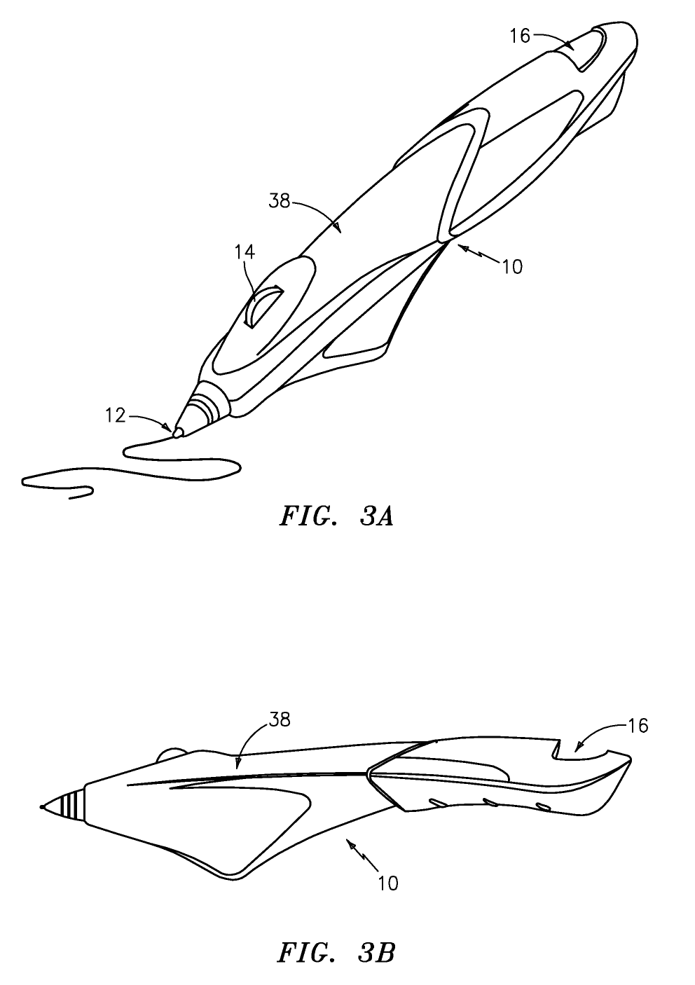

Referring now to FIG. 3A, the million color marker 10 is shown in a single hand-held operating mode.

Referring now to FIG. 3B, the million color marker 10 is shown having a dispensing tip 12, scroll wheel 14, LED color identifier 16, and rubberized grip 38. The roller ball 12 provides feedback to the controller so that the writing speed is known and the controller can adjust the rate of ink delivery to match such writing speed.

Referring now to FIG. 3C, the million color marker 10 is shown in a side elevation view in a horizontal position with the same features mentioned above in FIG. 3B.

### Other Features:

The dimensions of the pen will be roughly cigar-tube in shape.

The pen will normally have an upright orientation, like a pen.

The pen will be easily operated by one hand.

### Mechanical Mechanisms:

Additional controls/sensing mechanisms on the pen:
A basic on-off switch
A tilt sensor so the pen will shut off if not held ‘near’ vertical.
A way of selecting which color for the pen to output. The selector method will be intuitive/simple for a person unfamiliar with the device to understand and use.

### Electronics:

The following electronics and or related electrical functional components are contained in the pen:
Power will be supplied by internal batteries. Small batteries with an appropriate form factor such as ‘coin cells’ or ‘button cells’ will be replaceably mounted inside the pen body to provide a power source.
The electronics package will send signals to each syringe of ink via the mechanical mechanism described above allowing for color mixing.
The signals will tell each servo/threaded rod assembly how much to turn thus how much ink to advance.
The signal sent to each syringe should correspond to the color select control on the pen. In this way, when the user selects Red, the electronics package will signal each syringe how much to advance of each ink to cause red to form in the mixing chamber and out the pen tip onto paper.
The device will be able to produce hundreds or thousands of varying colors selected by the user. The number or resolution of colors produced by the pen will be limited only by the ability of the components to mix varying quantities of color. The final number of colors produced, depending upon components, could very well be millions.
A superior method of switching colors without having to change pens or click to extend or retract different pen tips housed in one enclosure.
Method of ink delivery is electronically controlled versus gravity feed methods and thus the pen is capable of writing in a variety of orientations including ‘upside down’.
Ink mixing technology is unique, both in terms of the mechanical apparatus, using algorithms to control the flow and mixing of inks to achieve the desired colors.

### Alternative Embodiments

Linear Actuator wire or air pumping mechanisms are alternative methods of achieving the desired downward pressure on the ink syringes causing ink to flow. These mechanisms are sent electrical signals to increase the pressure in the ink cartridge or reservoirs so as to cause varying flow rates. More pressure in a particular cartridge will cause more ink to flow so that one can vary the amount of each ink color that is pumped to the mixing chamber. Certain precautions are taken to prevent backflow from a higher pressure cartridge to a lower pressured cartridge such as one way valves. Linear actuators are well known in the art and can be used to drive plungers in the cartridge. Air pump mechanisms can increase the air pressure in each cartridge individually so as to cause differing flow rates for each ink supply. Other means of achieving this linear actuation are possible.

A peristaltic pumping mechanism maybe used to cause ink flow from each reservoir to the mixing chamber. Miniature peristaltic pumps are matched to the appropriate tubing (size and flexibility) to provide the desired flow rates. Electrical signals are provided to the pumps from the controller.

Although the above specification describes the pen dispensing tip as a roller ball, many other types of dispensing tips or pens may be used in this invention depending upon the desired application including but not limited to felt, quill, brush, miniature orifice, volcano tip, technical pens, lettering pens, porous-pointed pens, or ball point pens with brass, steel, or tungsten carbide as their writing tip.

Alternative methods of the user selecting colors include a separate control mechanism such as a mouse-wheel selector, joystick, color wheel, or other control that can be used by the user's non-writing hand as they write with the pen in their dominant hand. This alternative control would be in electronic communication with the pen's internal controller. It is also envisioned that voice command can be used to select the color output of the pen.

Other alternatives designs include attaching the pen via a tether to a specially designed tablet or easel with color select and other controls available on the tablet/easel surface.

### Additional Features

Auto color cycle mode—The user will be able to select this mode and thereafter the ink color will change randomly. There may be user inputs for dwell time for each color, range of colors selected (such as whole spectrum or just shades of red, yellow and greens), and

Sensing Accelerations—a multi-axis accelerometer may be incorporated into the circuit board or controller (MEMS and Nanotechnology) along with motion/acceleration sensing algorithms to control and adapt ink flow to various orientations or movement.

Temperature, Humidity, Barometric Sensors—environmental parameters may be determined through appropriate sensors and software/firmware compensation routines can be integrated into the control algorithm. Airline travel (varying barometric pressure), climatic zones and other factors may require compensation in ink flow and or pressure to achieve optimal writing performance.

Color reader—the pen will ‘read’ a surface color and reproduce it. An integrated reading device such as a CCD or a color spectrometer contained in the pen will illuminate and sense a surface color. The mixing unit will then be commanded to mix the appropriate inks to render the same color output at the dispensing tip. Alternatively the color reader can be an external device in communication with pen through various communication technologies (see next paragraph).

The pen may communicate with an external controller using USB, Bluetooth, Infrared or other appropriate communication technologies to download a variety of information including but not limited to preselected color palettes, for example:
Pastel colors
Southwest colors
Glittery colors
Range of hues of one color particularly for artists

Different pen casings will be offered to accommodate styles attractive to children (such as incorporation of Trademark characters like Spiderman), TV personalities, various sports or related franchises, professional trades such as engineers, firemen, or teachers. Pen casings may be designed over interne websites with selectable components.

This technology is directly applicable to other markets. Some of these include:

Toys—packages of multi-color pens, crayons and markers have always been a mainstay of the toy sector.

Art products—offering the capability to choose a particular shade from a range of hues of one color and many other potential concepts.

Branding—color coded branding of products.

Hair Coloring—for use in a beauty salon or personal use at home to mix various hair coloring dyes to produce any color desired. The technology can also be used to apply highlights selectively to various sections of one's hair.

Baking—in decorative equipment for controlling and changing colors for icing cakes, cupcakes, pastries and the like.

Body Art—The color control and mixing apparatus may be used in permanent or semi-permanent tattooing. The artist can control or change ink colors in his tools to apply permanent or temporary body art.

Medical Applications—use by doctors, nurses or self medication for injecting multiple drugs in varying percentages.

Education—Application to digital pen technology (such as SmartBoard); elementary grades for one pen to replace crayons and/or markers.

Branding—color coded branding of products.

Wherefore I claim:

1. A writing instrument for writing on, marking, and or coloring objects, paper, or
other suitable surfaces comprising:
a pen-like body having multiple reservoirs, each said reservoir containing a different color substance for dispensing on said surface;
a color selector having a range of user selectable positions;
whereby said user varies said position of said color selector causing said writing instrument to dispense a different color on said surfaces for each said user selectable position.

2. A writing instrument for writing on, marking, and or coloring objects, paper, or
other suitable surfaces comprising:
a handheld pen body having multiple ink reservoirs, each said reservoir having pumping means and a different color ink;
a mixing chamber in fluid communication with each of said multiple reservoirs;
said mixing chamber having a dispensing outlet;
a color selector having a range of user selectable positions, said selector in electronic communication a controller;
said controller in electronic communication with each said pumping means in each of said reservoirs;
said controller activating each of said pumping means to provide a predetermined amount of each said ink to said mixing chamber;
whereby said user varies said position of said color selector causing said mixing chamber to dispense a varying color for each said position and said user may vary the color dispensed from said pen body.

3. A writing instrument as in claim 2 and further comprising:
a power switch for toggling said writing instrument into an ON state or an OFF state;
a variable color display in communication with said controller;
wherein said controller commands the said color display to emit a color for visual reception by a user that coincides with the same color commanded by said controller to dispense from the dispensing outlet.

4. A writing instrument as in claim 2 wherein said color display is a light emitting diode display.
